(19) United States
(12) Patent Application Publication
(10) Pub. No.: US 2026/0106935 A1
(43) Pub. Date: Apr. 16, 2026

(54) SYSTEM AND METHOD FOR HANDLING EMERGENCY INTERACTIONS IN A CONTACT CENTER HAVING AGENTS HANDLING CONCURRENT INTERACTIONS

(71) Applicant: NICE LTD., Ra'anana (IL)

(72) Inventors: Swati KADU, Pune (IN); Prateek GUPTA, Pune (IN); Darpan WANKHEDE, Pune (IN)

(21) Appl. No.: 18/911,276

(22) Filed: Oct. 10, 2024

(51) Int. Cl. H04M 3/51; H04M 3/523

(52) U.S. Cl. CPC H04M 3/5116; H04M 3/5233; H04M 2242/04

(57) ABSTRACT

A computerized-method for handling emergency digital interactions in a contact center having agents handling concurrent interactions. The computerized-method includes for each agent in the contact center: (i) monitoring each real-time digital-interaction of an agent with a customer, that was routed by a ACD application, wherein the agent is concurrently handling two or more interactions via a User Interface (UI) that is associated to an application for handling concurrent interactions; (ii) operating an interaction-analyzer module on the monitored real-time digital-interaction to yield interaction-metadata; (iii) operating a prioritization module on the yielded interaction-metadata of the monitored real-time digital-interaction to set an emergency-mode thereto; The emergency-mode is one of: ‘on’ and ‘off’, and (iv) operating an interaction-handler module to prioritize the monitored real-time digital-interaction when the emergency-mode has been set to ‘on’ and move the agent into emergency-handling-mode.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever

### TECHNICAL FIELD

The present disclosure relates to the field of systems and methods for handling emergency digital interactions in a contact center having agents handling concurrent interactions.

### BACKGROUND

With rapid adoption of digital platforms, there is an increase in agents which are concurrently handling multiple interactions, as it increases contact center productivity. With emergency services utilization of digital platforms, agents handling concurrent interactions have to focus on the emergency interaction instead of the non-emergency interactions.

Hence there is a need for a technical solution that will enable the agent to focus on the emergency interaction that is received when the agent is working on concurrent interactions, such that emergency interactions are given due attention and focus.

### SUMMARY

There is thus provided, in accordance with some embodiments of the present disclosure, a computerized-method for handling emergency digital interactions in a contact center having agents handling concurrent interactions.

Furthermore, in accordance with some embodiments of the present disclosure, the computerized-method may include for each agent in the contact center: (i) monitoring each real-time digital-interaction of an agent with a customer, that was routed by an Advanced Contact Distributor (ACD) application, wherein the agent is concurrently handling two or more interactions via a User Interface (UI) that is associated to an application for handling concurrent interactions; (ii) operating an interaction-analyzer module on the monitored real-time digital-interaction to yield interaction-metadata; (iii) operating a prioritization module on the yielded interaction-metadata of the monitored real-time digital-interaction to set an emergency-mode thereto. The emergency-mode is one of: ‘on’ and ‘off’; and (iv) operating an interaction-handler module to prioritize the monitored real-time digital-interaction when the emergency-mode has been set to ‘on’ and move the agent into emergency-handling-mode.

Furthermore, in accordance with some embodiments of the present disclosure, the interaction-analyzer module may include: (i) checking one or more preconfigured parameters in the real-time digital-interaction. Each parameter in the one or more preconfigured parameters is related to one category of: a. critical service; b. customer behavior; and customer information; and (ii) scoring each parameter in the one or more parameters based on preconfigured mapping values to yield the interaction-metadata.

Furthermore, in accordance with some embodiments of the present disclosure, the prioritization module may include: (i) setting the emergency-mode to ‘on’ according to formula I:

$$If \sum ( preconfigured emergency keywords unique occurrence count in interaction ) > x set emergency - mode to ‘ on ’ , \qquad ( I )$$

whereby x is a positive number greater than ‘0’,
(ii) calculating an Emergency Interaction Priority Score (EIPS) for each real-time digital-interaction that the emergency-mode has been set to ‘on’, based on the interaction-metadata,
   the calculating of the EIPS is according to formula II:

$$EIPS = \sum ( parameters score related to critical service * W 1 ) + ( parameters score related to customer behavior * W 2 ) + ( parameters score related to customer information * W 3 ) ; \qquad ( II )$$

and
(iii) prioritizing the real-time digital interactions in descending order of EIPS.

Furthermore, in accordance with some embodiments of the present disclosure, the two or more interactions include at least one of: real-time interactions and asynchronous interactions.

Furthermore, in accordance with some embodiments of the present disclosure, the interaction-handler module is prioritizing the monitored real-time digital-interaction when the emergency-mode has been set to ‘on’ by moving real-time digital-interactions that their emergency-mode is not set to ‘on’ to other agents and defocusing asynchronous interactions.

Furthermore, in accordance with some embodiments of the present disclosure, the interaction-handler module may further include monitoring the prioritized real-time digital-interaction to determine completion thereof and moving the agent out from the emergency-handling-mode.

Furthermore, in accordance with some embodiments of the present disclosure, when the agent is moved into emergency-handling-mode the computerized-method further comprising displaying a pop-up message on the UI.

Furthermore, in accordance with some embodiments of the present disclosure, when the agent is moved into emergency-handling-mode the computerized-method further comprising displaying an icon indicating the emergency-handling-mode of the agent on the UI.

Furthermore, in accordance with some embodiments of the present disclosure, when the agent is moved into emergency-handling-mode the computerized-method may further include: (i) displaying an emergency visual indicator with the interaction type on the UI; and (ii) configuring the ACD application to set a status of the agent to ‘emergency-unavailable’, wherein when the status of the agent is set to ‘emergency-unavailable’ the ACD application is not routing any interaction to the agent.

Furthermore, in accordance with some embodiments of the present disclosure, when the agent completes the prioritized monitored real-time digital-interaction, the computerized-method further comprising setting the emergency-mode to ‘off’ and moving the agent out of emergency-handling-mode.

Furthermore, in accordance with some embodiments of the present disclosure, the computerized-method may further include determining an emergency category to the monitored real-time digital-interaction when the emergency-mode has been set to ‘on’, based on preconfigured mapping.

Furthermore, in accordance with some embodiments of the present disclosure, when the agent is moved into emergency-handling-mode the computerized-method further comprising displaying the emergency category on the UI in a section related to the monitored real-time digital-interaction.

Furthermore, in accordance with some embodiments of the present disclosure, when more than one real-time digital-interaction has been set to ‘on’, the computerized-method further comprising prioritizing the real-time digital-interactions, based on the calculated EIPS.

Furthermore, in accordance with some embodiments of the present disclosure, the application for handling concurrent interactions receives voice and digital interactions.

### BRIEF DESCRIPTION OF THE DRAWINGS

FIGS. 1A-1B schematically illustrate a high-level diagram of a system for handling emergency digital interactions in a contact center having agents handling concurrent interactions, in accordance with some embodiments of the present disclosure;

FIG. 2 is a high-level workflow of a computerized-method for handling emergency digital interactions in a contact center having agents handling concurrent interactions, in accordance with some embodiments of the present disclosure;

FIG. 3 is a high-level workflow of a computerized-method for handling emergency digital interactions in a contact center having agents handling concurrent interactions, in accordance with some embodiments of the present disclosure;

FIG. 4 is a high-level workflow of a computerized-method for handling emergency digital interactions in a contact center having agents handling concurrent interactions, in accordance with some embodiments of the present disclosure;

FIG. 5 is a high-level workflow of a recommendation engine, in accordance with some embodiments of the present disclosure;

FIG. 6 is a high-level workflow of an interaction-analyzer module, in accordance with some embodiments of the present disclosure;

FIG. 7 is a high-level workflow of a prioritization module, in accordance with some embodiments of the present disclosure;

FIG. 8 is a high-level workflow of an interaction-handler module, in accordance with some embodiments of the present disclosure;

FIG. 9 schematically illustrates a high-level diagram of a system for handling emergency digital interactions in a contact center having agents handling concurrent interactions, in accordance with some embodiments of the present disclosure;

FIG. 10 illustrates a screenshot of a User Interface (UI) for agent interactions with customers when emergency-mode is ‘off’, in accordance with some embodiments of the present disclosure;

FIG. 11 illustrates a screenshot of a UI for agent interactions with customers when emergency-mode is ‘on’ and emergency pop-up, in accordance with some embodiments of the present disclosure;

FIG. 12 illustrates a screenshot of a UI for agent interactions with customers when emergency-mode is ‘on’, after user click on pop-up, in accordance with some embodiments of the present disclosure;

FIG. 13 illustrates a screenshot of a UI for agent interactions with customers when emergency-mode is ‘on’, and a warning pop-up after the agent clicks to move to a non-emergency interaction, in accordance with some embodiments of the present disclosure;

FIG. 14 illustrates a screenshot of a dashboard for a supervisor to monitor emergency interactions, in accordance with some embodiments of the present disclosure; and

FIGS. 15A-15B is a table of categories and related parameters of interaction-metadata, in accordance with some embodiments of the present disclosure.

### DETAILED DESCRIPTION

In the following detailed description, numerous specific details are set forth in order to provide a thorough understanding of the disclosure. However, it will be understood by those of ordinary skill in the art that the disclosure may be practiced without these specific details. In other instances, well-known methods, procedures, components, modules, units and/or circuits have not been described in detail so as not to obscure the disclosure.

Although embodiments of the disclosure are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium (e.g., a memory) that may store instructions to perform operations and/or processes.

Although embodiments of the disclosure are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently. Unless otherwise indicated, use of the conjunction “or” as used herein is to be understood as inclusive (any or all of the stated options).

Currently, agents in contact centers can concurrently work on two interactions without giving full attention to an interaction, such as emergency interaction, which needs attention and focus. An emergency interaction should always have the focus of the agent.

Therefore, there is a need for a technical solution that will differentiate the focus and defocus in the interactions based on the interaction context.

There is a need for methods and systems for handling emergency digital interactions in a contact center having agents handling concurrent interactions based on the interaction context, e.g., keywords, emotions and sentiments.

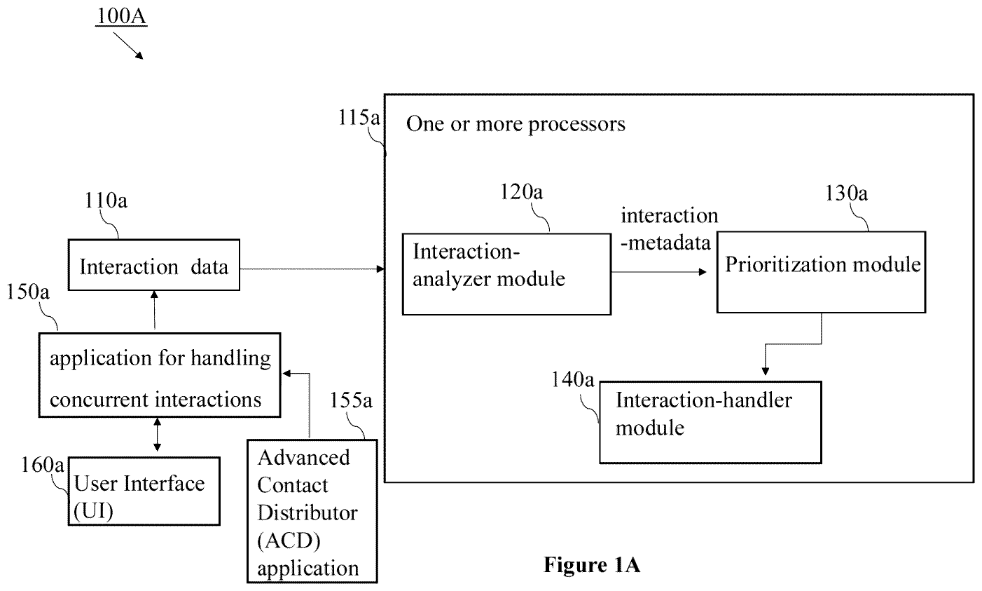

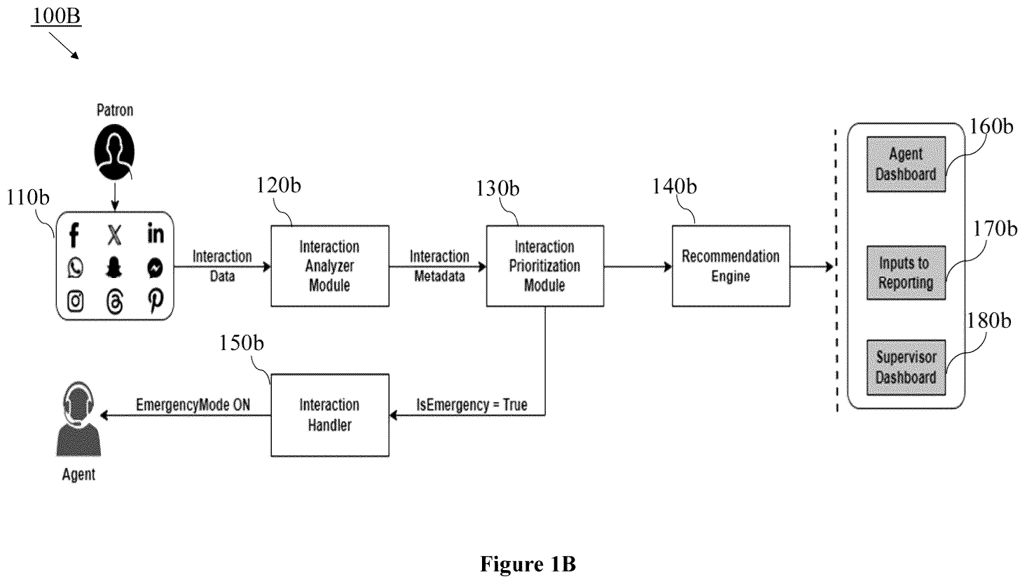

FIG. 1A schematically illustrates a high-level diagram of a system 100A for handling emergency digital interactions in a contact center having agents handling concurrent interactions, in accordance with some embodiments of the present disclosure.

According to some embodiments of the present disclosure, with increased adoption of emergency services on the digital platform, such as 911, language translation, health, counselling, psychotherapy services, accidental insurance and hospitalization services, there is a need for a system, such as system 100A for handling emergency digital interactions in a contact center having agents handling concurrent interactions.

According to some embodiments of the present disclosure, system 100A may provide priority to interactions based on their severity and criticality, in particular when the agents are handling concurrent interactions at the time that the emergency interaction is received or handled and enforced by a User Interface (UI) 160a that is associated to an application for handling concurrent interactions 150a, to focus on the emergency interactions and ensure that emergency interactions are given due attention and focus. The application for handling concurrent interactions 150a may receive voice and digital interactions.

According to some embodiments of the present disclosure, for each agent in the contact center, system 100A may monitor each real-time digital interaction of the agent with a customer, that was routed by an Advanced Contact Distributor (ACD) application 155a. The agent may be concurrently handling two or more interactions via a User Interface (UI) 160a that is associated to an application for handling concurrent interactions 150a. The two or more interactions may include at least one of: real-time interactions and asynchronous interactions.

According to some embodiments of the present disclosure, one or more processors 115a in system 100A may operate an interaction-analyzer module 120a on interaction data of the monitored real-time digital-interaction to yield interaction-metadata.

According to some embodiments of the present disclosure, the interaction-metadata may include preconfigured parameters that the interaction-analyzer module 120a may check in the real-time digital-interaction. Each parameter in the preconfigured parameters may be related to one category of: a. critical service; b. customer behavior; and customer information. Then, the interaction-analyzer module 120a may score each parameter in the parameters of each category based on preconfigured mapping values to yield the interaction-metadata.

According to some embodiments of the present disclosure, the interaction-handler module 120a may prioritize the monitored real-time digital-interaction when the emergency-mode has been set to ‘on’ by moving real-time digital-interactions that their emergency-mode is not set to ‘on’ and are currently assigned to the agent to other agents and defocusing asynchronous interactions which are currently assigned to the agent.

According to some embodiments of the present disclosure, the interaction-handler module 120a may further monitor the prioritized real-time digital-interaction to determine completion thereof and may move the agent out from the emergency-handling-mode upon completion of the prioritized real-time digital-interaction, e.g., interaction that its emergency-mode has been set to ‘on’.

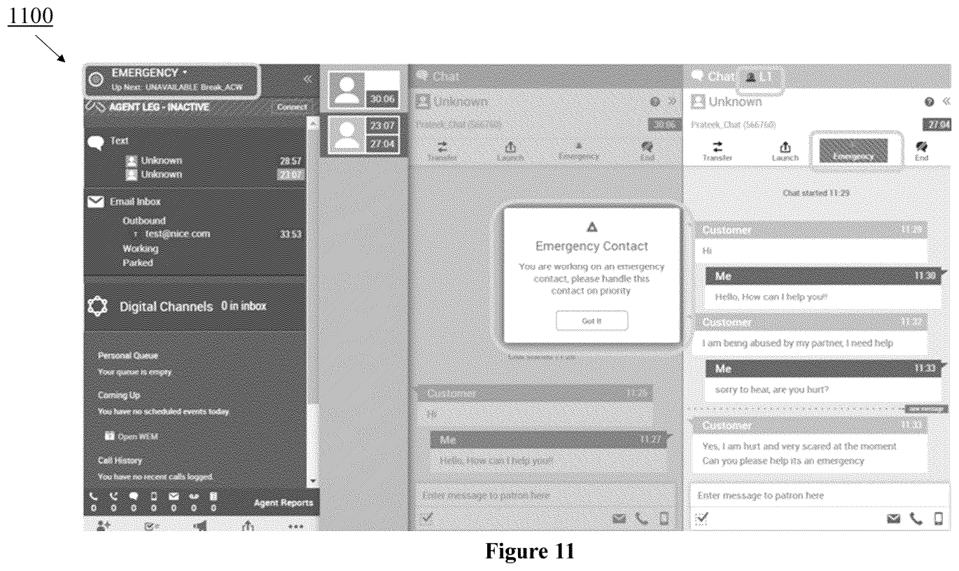

According to some embodiments of the present disclosure, when the agent is moved into emergency-handling-mode, to handle the interaction that its emergency-mode has been set to ‘on’, a pop-up message may be displayed on the UI 160a, for example, as shown in UI 1100 in FIG. 11.

According to some embodiments of the present disclosure, when the agent is moved into emergency-handling-mode, an icon indicating the emergency-handling-mode of the agent may be displayed on the UI 160a, for example, as shown in UI 1100 in FIG. 11.

According to some embodiments of the present disclosure, when the agent is moved into emergency-handling-mode, an emergency visual indicator with the interaction type may be displayed on the UI 160a, for example, as shown in UI 1100 in FIG. 11.

According to some embodiments of the present disclosure, when the agent is moved into emergency-handling-mode, the one or more processors 115a may configure the ACD application 155a to set a status of the agent to ‘emergency-unavailable’ such that when the status of the agent is set to ‘emergency-unavailable’, the ACD application 155a is not routing any interaction to the agent.

According to some embodiments of the present disclosure, an emergency category may be determined to the monitored real-time digital-interaction when the emergency-mode has been set to ‘on’, based on a preconfigured mapping of the parameters in each category and scale of values for ach

According to some embodiments of the present disclosure, when the agent is moved into emergency-handling-mode, the emergency category may be displayed on the UI in a section related to the monitored real-time digital-interaction. For example, as shown in UI 1100 in FIG. 1100.

According to some embodiments of the present disclosure, a prioritization module 130a may be operated on the yielded interaction-metadata of the monitored real-time digital-interaction to set an emergency-mode thereto. The emergency-mode may be one of: ‘on’ and ‘off’.

According to some embodiments of the present disclosure, the prioritization module 130a may include setting the emergency-mode to ‘on’ according to formula I:

$$If \sum ( preconfigured emergency keywords unique occurrence count in interaction ) > x set emergency - mode to ‘ on ’ , \qquad ( I )$$

whereby x is a positive number greater than ‘0’.

According to some embodiments of the present disclosure, the prioritization module 130a may calculate an Emergency Interaction Priority Score (EIPS) for each real-time digital-interaction that the emergency-mode has been set to ‘on’, based on the interaction-metadata. The calculating of the EIPS is according to formula II:

$$EIPS = \sum ( parameters score related to critical service * W 1 ) + ( parameters score related to customer behavior * W 2 ) + ( parameters score related to customer information * W 3 ) , \qquad ( II )$$

whereby W1-W3 are weights associated to each parameters score. Then, prioritizing the real-time digital interactions in descending order of EIPS.

According to some embodiments of the present disclosure, critical service may be identified through pre-configured emergency or critical service keywords occurrence in the interaction. Critical service, customer behavior and customer information may be used to determine the priority of an emergency interaction in case there are multiple emergency interactions. For example, in case of riots/pandemic situations/natural disasters like earthquake, a contact center may be flooded with many digital interactions, so the contact center may use a system such as system 100A in FIG. 1A or system 100B in FIG. 1B to prioritize the most critical digital interactions to handle it.

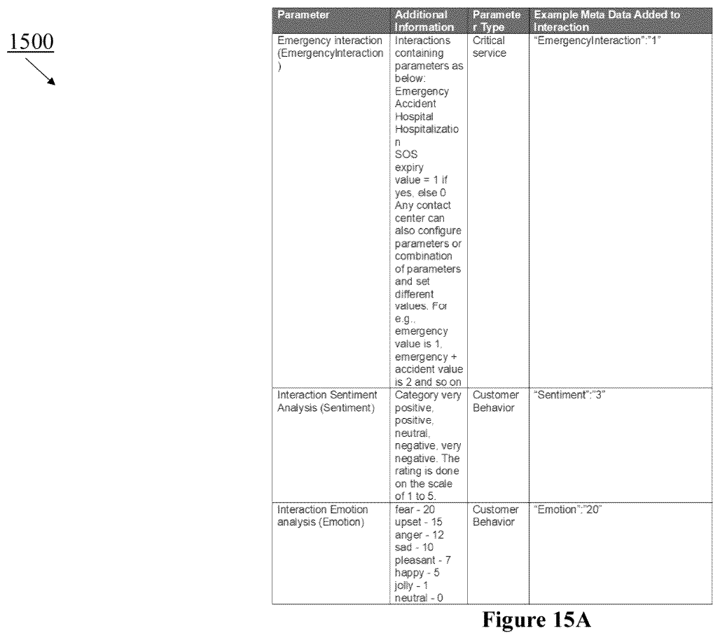

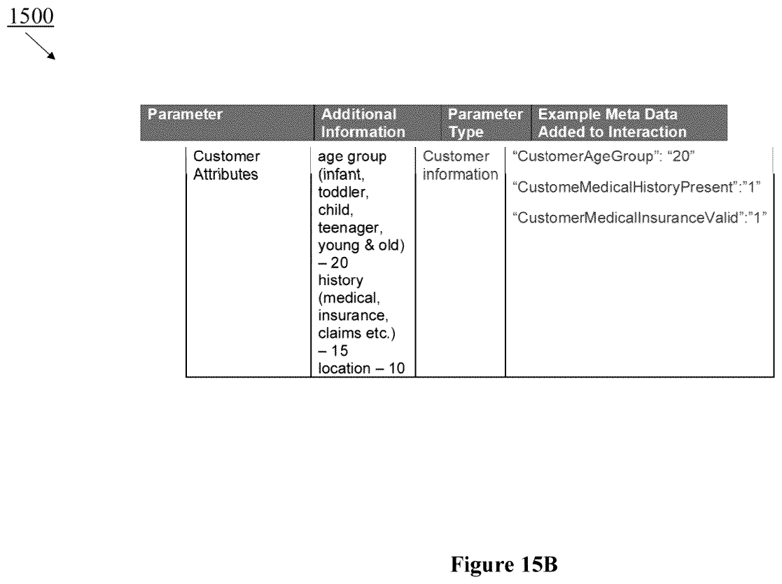

According to some embodiments of the present disclosure, the parameters related to critical service may be emergency interaction which is set to ‘1’ when the interaction includes a preconfigured number of keywords from a list of keywords, such as emergency, accident, hospital, hospitalization, SOS, and the like. The parameters related to customer behavior may be sentiment and emotion. The sentiment may be for example in a scale of ‘0’ to ‘5’ and the emotion may be for example several parameters such as fear, upset, anger, sad, pleasant, happy, jolly and neutral, each in a predetermined scale of values. The parameters related to customer information may be for example, age group such as infant, toddler, child, teenager, young and old, medical history, medical insurance and location e.g., customers from geographical hazards, pandemic areas, crime/riots at specific location. For example, as shown in table 1500 in FIGS. 15A-15B.

According to some embodiments of the present disclosure, when more than one real-time digital-interaction has been set to ‘on’, for the agent, the real-time digital-interactions may be prioritized, based on the calculated EIPS.

According to some embodiments of the present disclosure, the one or more processors 115a may further operate an interaction-handler module 140a to prioritize the monitored real-time digital-interaction when the emergency-mode has been set to ‘on’ and move the agent into emergency-handling-mode.

According to some embodiments of the present disclosure, when the agent completes the prioritized monitored real-time digital-interaction, the emergency-mode may be set to ‘off’ and the agent is moved out from the emergency-handling-mode.

FIG. 1B schematically illustrates a high-level diagram of a system 100B for handling emergency digital interactions in a contact center having agents handling concurrent interactions, in accordance with some embodiments of the present disclosure.

According to some embodiments of the present disclosure, a system, such as system 100B may include similar components as system 100A in FIG. 1A.

According to some embodiments of the present disclosure, a system, such as system 100B may continuously monitor an ongoing interaction and check for emergency keywords based on interaction-metadata to determine whether the interaction is emergency or non-emergency. The interaction may be from digital platforms 110b.

According to some embodiments of the present disclosure, the count of the emergency keywords from the interaction-metadata may be checked and when it may be above a preconfigured threshold, the interaction may be determined as an emergency interaction. For example, based on formula I:

(I) Σ (Emergency keywords count)>x then considering the interaction as emergency, whereby x is a positive number greater than ‘0’. The emergency keywords may be preconfigured in the system and may be updated from time to time. For example, as shown in table 1500 in FIGS. 15A-15B.

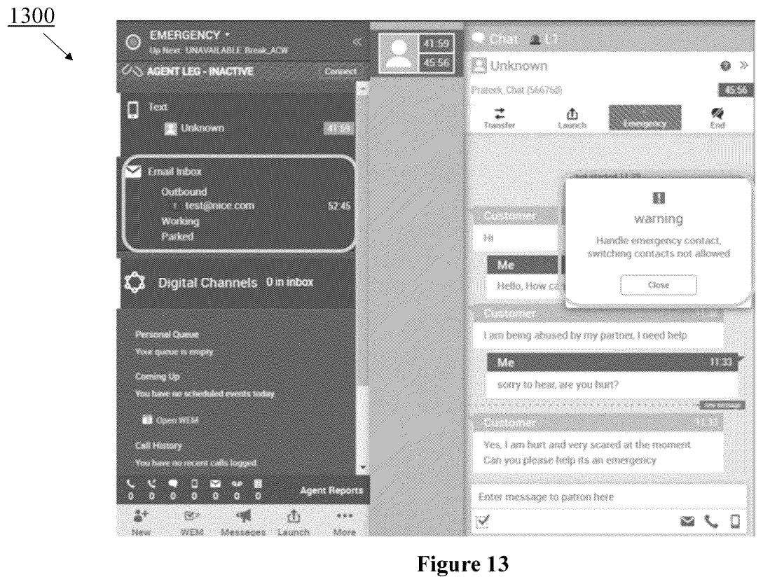

According to some embodiments of the present disclosure, once the interaction is identified as an emergency, then an Emergency Interaction Priority Score (EIPS) may be calculated for the interaction and if the agent is working on multiple concurrent interactions, then the other non-real-time interactions of the agent may be defocused and other real-time interactions may be automatically re-queued to another available agent that is not handling an emergency interaction. The agent may be enforced via the UI that is associated to the application for handling concurrent interactions, to work only on the emergency interaction. For example, as shown in UI 1300 in FIG. 13.

According to some embodiments of the present disclosure, the EIPS may be calculated according to formula II:

$$EIPS = \sum ( parameters score related to critical service * W 1 ) + ( parameters score related to customer behavior * W 2 ) + ( parameters score related to customer information * W 3 ) . \qquad ( II )$$

Whereby: parameters score related to critical service are parameters that consider critical interactions, i.e., interactions catering to emergency services, interactions that deal with accidental insurance, products, or

$$services = {\prod }_{i = 0}^{n} ( Critical Service category parameter ) i ,$$

parameters score related to customer behavior are parameters which provide information about the customer's sentiment and emotion as expressed in

$$the interaction = {\prod }_{i = 0}^{n} ( Customer Behaviour category parameters ) i ,$$

and parameters score related to customer information are parameters that relate to the customer information, like age group,

$$historic interaction of customer = {\prod }_{i = 0}^{n} ( Customer Information parameters ) i$$

According to some embodiments of the present disclosure, an interaction workspace may be highlighted in emergency theme design, once identified as emergency contact. An agent state may be set to an emergency-mode, by switching the emergency on while working on emergency contact to make sure that no new interaction is assigned to agent, by the ACD application or that the agent doesn't independently switch to a non-emergency interaction, until emergency interaction is worked upon.

According to some embodiments of the present disclosure, whenever an emergency interaction is identified and an agent is working on multiple concurrent interactions, the other non-real-time interactions, such as email, SMS, voicemail and work-item i.e., an interaction type assigned to agent to carry on a predefined work, and the like, will be defocused automatically and real-time interactions like calls, chats will be re-queued to other available agents, and the agent can work only on emergency interactions.

According to some embodiments of the present disclosure, emergency prioritization may be used to focus on emergency interactions. The interactions may be consistently prioritized based on the calculated EIPS.

According to some embodiments of the present disclosure, system 100B may ensure that digital interactions are prioritized dynamically so that emergency interactions which have high severity and criticality are responded at a faster pace as compared to non-emergency interactions.

According to some embodiments of the present disclosure, system 100B may determine That an interaction is an emergency interaction based on the preconfigured keywords that determine an emergency for each respective tenant of a software as a service hosted in a cloud environment of a service provider. For example, a tenant that is in emergency care services business, then keywords like emergency, pain, heart attack, head injury, breathing issues, hurt, death, dying etc. can indicate an emergency. The keywords can be updated from time to time to indicate the emergencies that the tenant would like to deal with on priority.

According to some embodiments of the present disclosure, the EIPS may be calculated based upon various parameter complexities for emergency interactions. Emergency Interaction Priority Score=Σ (critical service category parameters*W1)+(customer behavior category parameters*W2)+(customer information category parameters*W3).

According to some embodiments of the present disclosure, via an interaction-analyzer module 120b, interactions may be continuously analyzed for identifying emergency interactions based on the keywords fed to the system. For example, when an interaction has keywords like emergency, need help, accident and the like, then it can be identified as an emergency interaction. The interaction analyser module 120b may also use an autocorrection software's, such as Spell Check API of Bing® for auto correction of words to enable accurate keyword matching.

According to some embodiments of the present disclosure, the following parameters may be captured by the interaction-analyzer module 120b. EmergencyInteraction, of critical type when the interaction includes the following keywords: ‘Emergency’, ‘Accident’, ‘Hospital’, ‘Hospitalization’, ‘SOS’, ‘expiry’, such that when the keyword is in the interaction, an accumulator parameter may add ‘l’ to a counter. Any contact center may configure parameters or combination of parameters and set different values. For example, emergency value is ‘1’, emergency value+accident value is ‘2’ and so on. The metadata added to the interaction may be for example, EmergencyInteraction is ‘1’.

According to some embodiments of the present disclosure, an interaction sentiment analysis of customer behavior type may categorize the interaction into several categories, such as ‘very positive’, ‘positive’ ‘neutral’, ‘negative’, and ‘very negative’ on a scale from ‘1’ to ‘5’. The metadata of the interaction may be for example, sentiment ‘3’.

According to some embodiments of the present disclosure, the interaction emotion, of customer behavior type may be measured by quantifying several parameters, for example, fear ‘20’, upset ‘15, anger ‘12’, sad ‘10’, pleasant ‘7’, happy ‘5’, jolly ‘1’ and neutral ‘0’. The metadata of the interaction may be for example, emotion ‘20’, which may be the value of a parameter of the category, as shown in table 1500 in FIGS. 15A-15B.

According to some embodiments of the present disclosure, customer attributes of customer information type may be measured based on age group, history and location. Each may be valued from ‘0’ up to a certain value. The metadata of the interaction may be for example, CustomerAgeGroup ‘20’, CustomerMediaclHistoryPresent ‘1’ and CustomerMedical Insurance Valid ‘1’.

According to some embodiments of the present disclosure, an interaction prioritization module 130b may calculate the priority, level and severity of the emergency interaction and set emergency mode to true, e.g. ‘on’. If multiple agent interactions are identified as emergency, then the emergency-mode may be turned on for high priority interaction for the agent and low emergency interaction is re-queued to another available agent with emergency mode turned on.

According to some embodiments of the present disclosure, the following parameters, which the interaction-analyzer module has identified as critical service parameters may be used by the prioritization module to calculate the EIPS. Emergency Interaction, Interaction Sentiment, Interaction Emotion and Customer attributes may be considered for the prioritization of emergency interactions. The parameter ‘Emergency Interaction’ is the sum of unique pre-defined emergency keyword count during the interaction. If the interaction contains a single emergency keyword, then the attribute value is ‘1’, if it contains 2 unique emergency keywords then the attribute value is ‘2’ and weight ‘200’. The emergency keywords are configured by the contact center per Tenant for example the following keywords: ‘Emergency’, Accident’, ‘Hospital’, ‘Hospitalization’ ‘SOS’, ‘expiry’, can be configured such that it helps the Tenant identify the emergency situation applicable to them, for example a hospital will have keywords like ‘Accident’, ‘Hospital’ configured whereas a insurance company will have keywords configured like ‘medical insurance’, ‘insurance’, ‘expiry’ etc. The score may be actual value*weight, 200*1=200.

According to some embodiments of the present disclosure, the parameter ‘interaction sentiment’ may be on a scale from ‘1’ to ‘5’, for example, ‘very positive’, ‘positive’ ‘neutral’, ‘negative’, and ‘very negative’ on the scale from ‘1’ to ‘5’. The score may be the actual value*weight, e.g., 5*10=50, as shown in table 1500 in FIGS. 15A-15B.

According to some embodiments of the present disclosure, the parameter ‘interaction emotion’ may be based on a preconfigured set of emotions, such as ‘fear’ and an attributed value, e.g., 20, ‘upset’ and an attributed value, e.g., 15, ‘anger’ and an attributed value, e.g., 12, ‘sad’ and an attributed value, e.g., 10, ‘pleasant’ and an attributed value, e.g., 7, ‘happy’ and an attributed value, e.g., 5, ‘jolly’ and an attributed value, e.g., 1, ‘neutral’ and an attributed value, e.g., 0.

According to some embodiments of the present disclosure, the parameter ‘Customer Attributes’ may be measured based on age group, history and location. Each may be valued from ‘0’ up to a certain value. The metadata of the interaction may be for example, CustomerAgeGroup ‘20’, CustomerMediaclHistoryPresent ‘1’ and CustomerMedical Insurance Valid ‘1’.

According to some embodiments of the present disclosure, the interaction-handler module 150b may turn on the emergency-mode and move the existing non-emergency real-time interaction of the agent to other available agents and existing asynchronous interactions which were assigned to the agent may be defocused. The emergency interaction may be monitored and once it is completed the emergency-mode of the agent may be changed to available, e.g., ‘off’ for handling concurrent interactions.

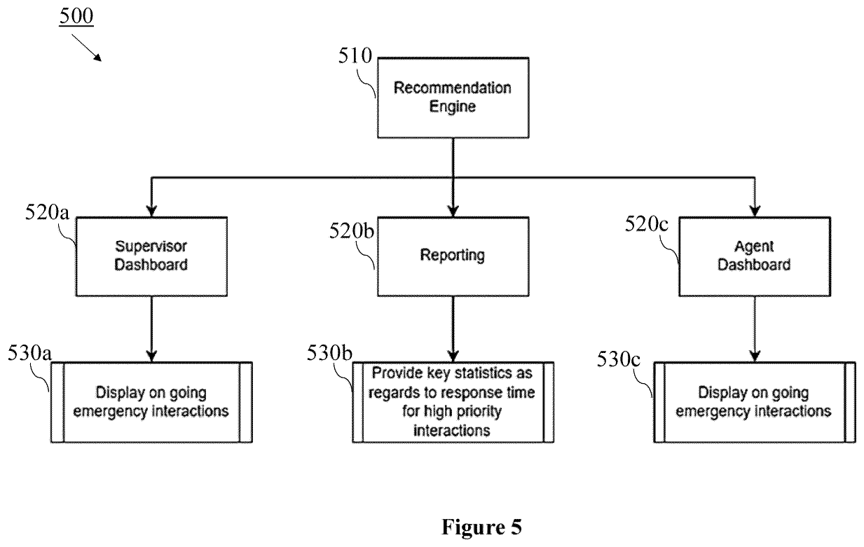

According to some embodiments of the present disclosure, a recommendation engine 140b may send recommendations to the agents and the supervisor for handling emergency interactions. For example, as shown in FIG. 5.

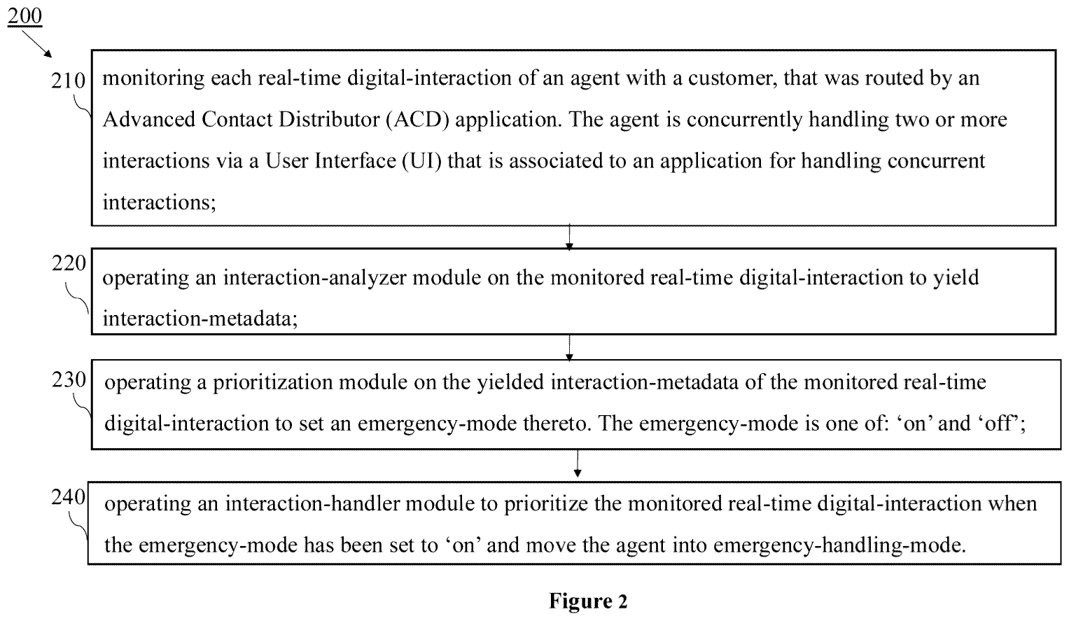

FIG. 2 is a high-level workflow of a computerized-method 200 for handling emergency digital interactions in a contact center having agents handling concurrent interactions, in accordance with some embodiments of the present disclosure.

According to some embodiments of the present disclosure, operation 210 comprising monitoring each real-time digital-interaction of an agent with a customer, that was routed by an Advanced Contact Distributor (ACD) application. The agent is concurrently handling two or more interactions via a User Interface (UI) that is associated to an application for handling concurrent interactions.

According to some embodiments of the present disclosure, operation 220 comprising operating an interaction-analyzer module on the monitored real-time digital-interaction to yield interaction-metadata.

According to some embodiments of the present disclosure, operation 230 comprising operating a prioritization module on the yielded interaction-metadata of the monitored real-time digital-interaction to set an emergency-mode thereto. The emergency-mode is one of: ‘on’ and ‘off’.

According to some embodiments of the present disclosure, operation 240 comprising operating an interaction-handler module to prioritize the monitored real-time digital-interaction when the emergency-mode has been set to ‘on’ and move the agent into emergency-handling-mode.

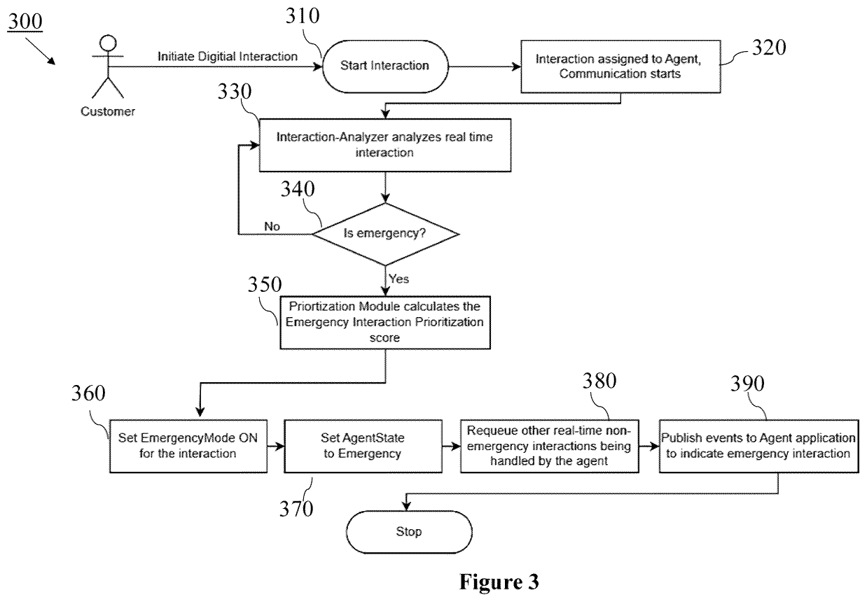

FIG. 3 is a high-level workflow 300 of a computerized-method for handling emergency digital interactions in a contact center having agents handling concurrent interactions, in accordance with some embodiments of the present disclosure.

According to some embodiments of the present disclosure, in a system, such as system 100A in FIG. 1A and such as system 100B in FIG. 1B, all interactions which are directed from the digital channels, may be analyzed in real-time to identify if the interaction is an emergency or non-emergency interaction. Once an interaction is identified as an emergency interaction, an Emergency Interaction Priority Score (EIPS) may be calculated to score the emergency level, and an interaction severity or criticality may be assigned.

According to some embodiments of the present disclosure, for emergency interactions, upon an emergency-mode that has been turned on, all concurrent real-time non-emergency interactions currently handled by the agent may be re-queued and asynchronous, non-real-time interactions may be automatically defocused. The agent may be forced to focus on the emergency interaction while via the UI that is associated to the application for handling concurrent interactions, for example, as shown in UI 1300 in FIG. 13. When the agent may try to handle the non-emergency interactions, a popup message may be displayed on the UI that says that switching contacts is not allowed.

According to some embodiments of the present disclosure, when customers reach out to the contact center with queries, a digital back-end platform creates a case for a digital channel and starts the interaction 310.

According to some embodiments of the present disclosure, based on the skill based unified routing mechanism of the ACD application, it automatically assigns the interaction to the agent inbox based on maximum contact handling bandwidth and communication starts 320. At the same time, there could be multiple contacts from different customers that show up in one agent inbox and presented via a UI associated to an application for handling concurrent interactions, such as UI 160a in FIG. 1A and application for handling concurrent interactions 150a in FIG. 1A.

According to some embodiments of the present disclosure, once the agent receives a customer, i.e., contact in the agent's inbox a module, such as the interaction-analyzer module 120a in FIG. 1A may analyze the real-time interaction 330 and may check for different parameters that are pre-configured. One such parameter is whether the interaction is emergency or non-emergency 340.

According to some embodiments of the present disclosure, if any of the interactions is identified as an emergency interaction, then a module, such as the prioritization module 130a in FIG. 1A may calculate the Emergency Interaction Priority Score (EIPS) for the emergency interaction 350 and pass the information to a module, such as the interaction handler module 140a in FIG. 1A. This score may be used to identify the emergency level, severity, and criticality of a customer issue. The score may be used in case multiple emergency interactions are identified for one agent to prioritize the emergency interactions.

According to some embodiments of the present disclosure, the prioritization module may turn on the emergency-mode for the interaction 360 and the interaction handler module may update the agent as to the emergency-mode of the interaction 370, via the UI, e.g., as shown in FIG. 11 and re-queue other real-time non-emergency interactions of the agent to other agents 380.

According to some embodiments of the present disclosure, the emergency interactions may be categorized based on the calculated EIPS. For example, in a category of critical emergency may be interactions with EIPS of 500 or above. In a category of high emergency may be interactions with EIPS 300 to 499 and medium emergency may be interactions with EIPS with 200 to 299.

According to some embodiments of the present disclosure, events may be published to the application, such as application for handling concurrent interactions 150a in FIG. 1A, to indicate emergency interaction 390. For example, as shown in UI 1100 in FIG. 11.

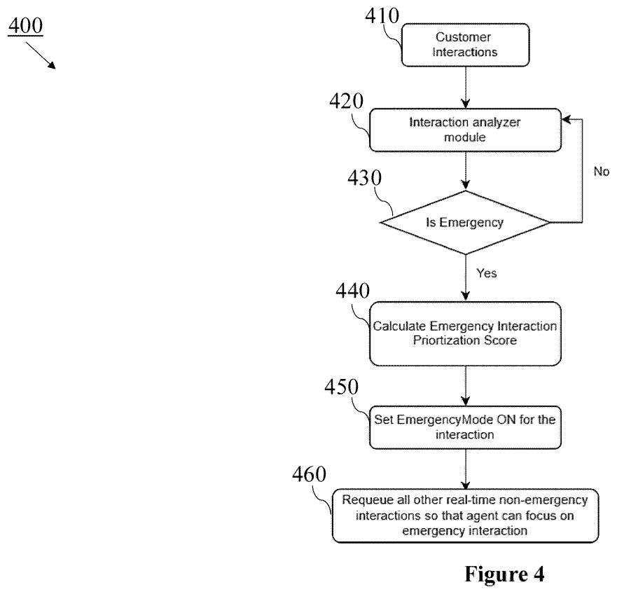

FIG. 4 is a high-level workflow 400 of a computerized-method for handling emergency digital interactions in a contact center having agents handling concurrent interactions, in accordance with some embodiments of the present disclosure.

According to some embodiments of the present disclosure, in a system, such as system 100A in FIG. 1A and such as system 100B in FIG. 1B, customer interactions 410 may be analyzed by an interaction-analyzer module 420, such as interaction-analyzer module 120a in FIG. 1A and such as interaction-analyzer module 120b in FIG. 1B. The interaction-analyzer module may analyze the interactions and generate metadata parameters to determine if the interaction is an emergency interaction 430. For example, an interaction may be set in emergency-mode ‘on’ based on the interaction-metadata as configured by the contact center.

According to some embodiments of the present disclosure, these parameters may be used to calculate an Emergency Interaction Priority Score (EIPS) 440 for all interactions that have been set in emergency-mode ‘on’. For emergency interaction, the emergency-mode is turned on 450 with all non-emergency non-real-time interactions defocused, and all other non-emergency real-time interactions re-queued so that the agent can focus on the emergency interaction 460.

According to some embodiments of the present disclosure, when customers have reached out to contact centers for their queries, a case may be created in the system and assigned to an agent, to start the communication between the agent and the customer.

According to some embodiments of the present disclosure, once the interaction is received in the agent's inbox, the interaction-analyzer module may analyze the real-time interaction and check for different parameters that are pre-configured to identify if the interaction is an emergency interaction.

According to some embodiments of the present disclosure, when the interaction is identified as emergency, then an EIPS is calculated for the interaction.

FIG. 5 is a high-level workflow 500 of a recommendation engine, in accordance with some embodiments of the present disclosure.

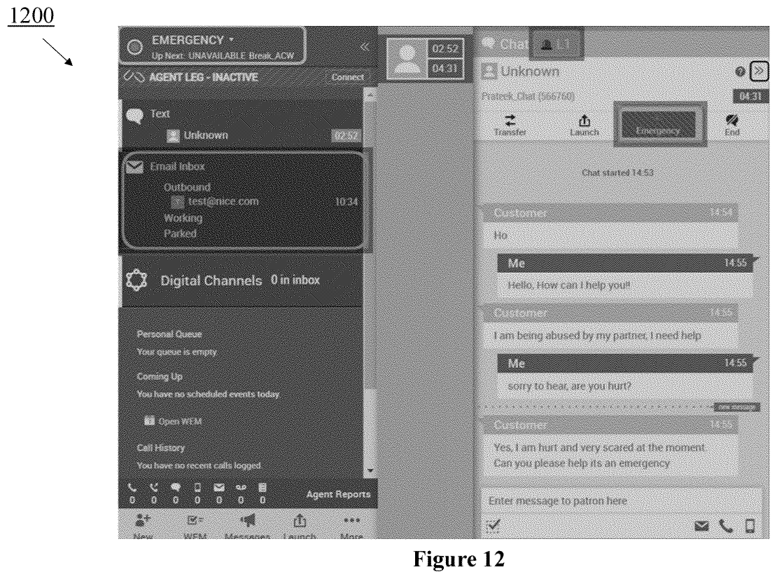

According to some embodiments of the present disclosure, the recommendation engine 510, such as recommendation engine 140b in FIG. 1B, may present to the agents the emergency interactions via the agent dashboard 520c and display on going emergency interactions 530c. For example, as shown in UI 1100 in FIG. 11, and UI 1200 in FIG. 12.

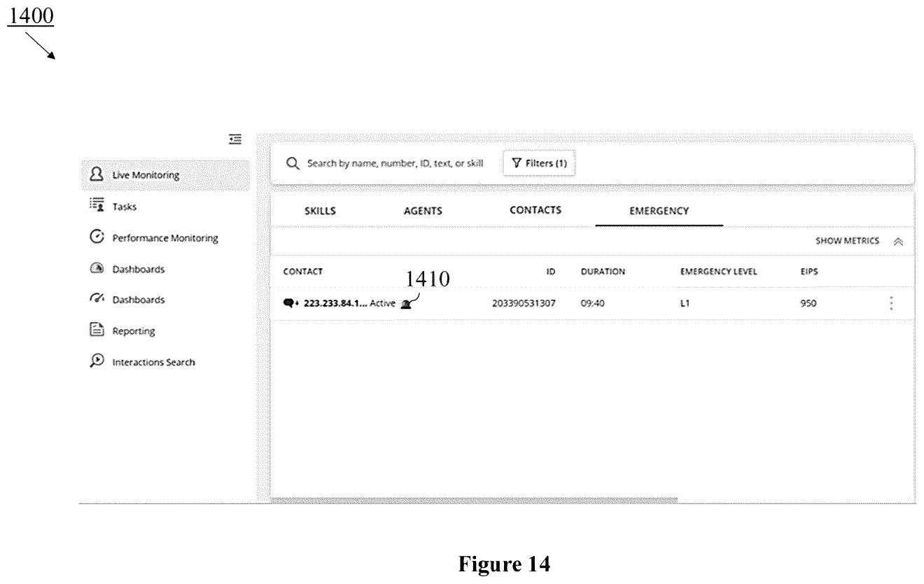

According to some embodiments of the present disclosure, the recommendation engine 510, such as recommendation engine 140b in FIG. 1B, may provide reporting 520b of the emergency interactions, for example, as shown in FIG. 14. The reporting 520b may provide key statistics related to response time for high priority interactions.

According to some embodiments of the present disclosure, the recommendation engine 510, such as recommendation engine 140b in FIG. 1B, may present the emergency interactions on the supervisor dashboard 520a and display on going emergency interactions 530a.

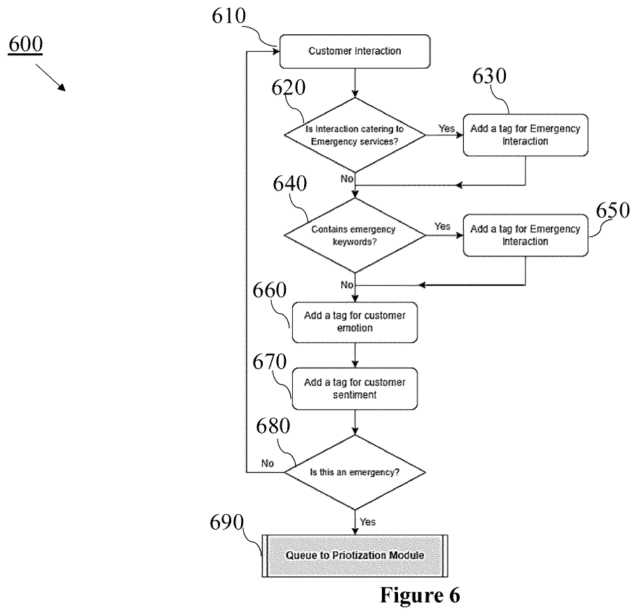

FIG. 6 is a high-level workflow 600 of an interaction-analyzer module, in accordance with some embodiments of the present disclosure.

According to some embodiments of the present disclosure, in a system, such as system 100A in FIG. 1A and such as system 100B in FIG. 1B, all digital customer interactions 610 may be analyzed in real-time to check if the interaction is catering to emergency services 620 like hospitalization, kidnapping and the like. If the interaction has critical service request, then the interaction may be tagged for emergency request 630.

According to some embodiments of the present disclosure, when the interaction is not catering for emergency service then it may be checked if it contains preconfigured emergency keywords 640. When the contact center deals with domains that exclusively don't handle emergencies, the agent may start an interaction, and the system may identify emergencies based on the configured keywords. For such services, definition of emergency may be different in each implementation and may be flexible as to the definition of emergency.

According to some embodiments of the present disclosure, if the interaction contains preconfigured emergency keywords, then a tag may be added for emergency interaction 650. For example, an interaction may start with a non-emergency situation but as it progresses the interaction could be categorized as emergency based on the ongoing interaction keywords. For example, a customer may raise a request saying that she has fell down and the agent may ask if it's an emergency to which the customer may confirm as an emergency.

According to some embodiments of the present disclosure, customer's emotion and sentiments may be analyzed and the interaction may be tagged for emotions 660 like fear, anger, sad and the like and tagged for customer sentiments 670.

According to some embodiments of the present disclosure, checking if the interaction is an emergency based on the interaction metadata 680 and when the interaction is identified as an emergency based on the analysis the interaction is transferred to prioritization queue 690.

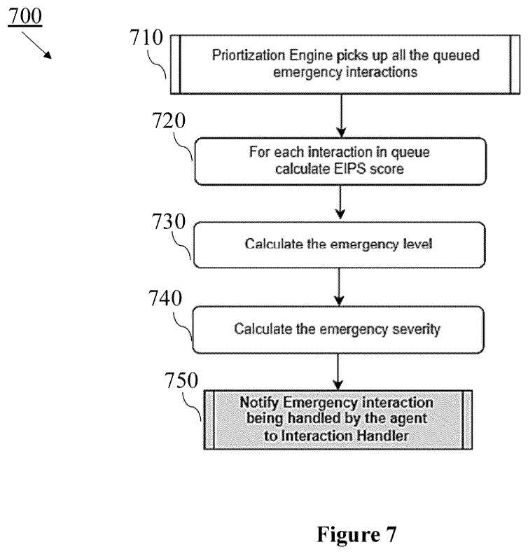

FIG. 7 is a high-level workflow 700 of a prioritization module, in accordance with some embodiments of the present disclosure.

According to some embodiments of the present disclosure, a prioritization module may pick up all the queues emergency interactions 710 ensuring that digital interactions are prioritized dynamically so that emergency interactions which have high severity and criticality are responded at a faster pace as compared to non-emergency interactions.

According to some embodiments of the present disclosure, an EIPS may be calculated for each interaction in the queue 720 based upon various parameter complexities for emergency interactions. The calculation of the EIPS may ensure that the agents know the priority of interactions assigned to them so that they may respond accordingly.

According to some embodiments of the present disclosure, when emergency interactions are transferred to a prioritization queue, the prioritization module, such as prioritization module 130a in FIG. 1A may be operated.

According to some embodiments of the present disclosure, the prioritization module may check all the emergency interactions in the prioritization queue and may calculate the emergency EIPS for all the emergency interactions in the prioritization queue.

According to some embodiments of the present disclosure, once the EIPS may be calculated, the emergency level of each interaction may be calculated 730 and the emergency severity of each interaction 740 based on the EIPS. For example, interactions in the range of 500 or above may be categorized as ‘critical emergency’, interactions in the range of 300 to 499 may be categorized as ‘high emergency’, and interactions in the range of 200 to 299 may be categorized as ‘medium emergency’.

According to some embodiments of the present disclosure, as soon as the priority level and severity is calculated for the interaction, the interaction handled by agent is notified to interaction handler module 750, such as interaction-handler module 140a in FIG. 1A, and the interaction handler may handle the of re-queuing, defocusing and indicating agent about emergency on the UI application.

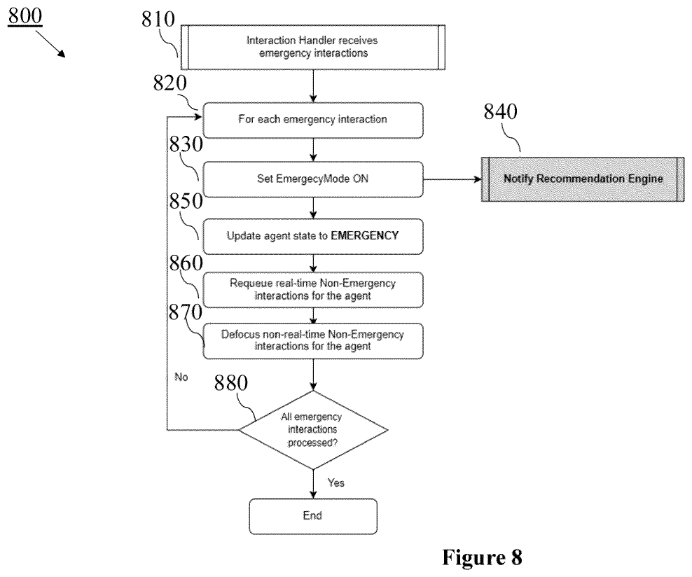

FIG. 8 is a high-level workflow 800 of an interaction-handler module, in accordance with some embodiments of the present disclosure.

According to some embodiments of the present disclosure, a system, such as system 100A in FIG. 1A and system 100B in FIG. 1B, may ensure that digital interactions are prioritized dynamically so that emergency interactions which have high severity and criticality are responded at a faster pace as compared to non-emergency interactions. Emergency-mode for the interaction that has been identified as emergency is turned on and all other non-emergency interactions may be re-queued with agent state changed to emergency-unavailable to make sure no further interaction is assigned to agent until the emergency issue arise in the interaction has been resolved.

According to some embodiments of the present disclosure, once the interaction-handler module, such as interaction-handler module 140a in FIG. 1A, may receive the notification for emergency interaction for the agent 810, it may capture all the interactions currently being handled by agent.

According to some embodiments of the present disclosure, for each emergency interaction 820 the interaction-handler module, such as interaction-handler module 140a in FIG. 1A, may set the emergency-mode ‘on’ 830 for the interaction on the agent application, e.g., application for handling concurrent interactions 150a in FIG. 1A, via the UI, such as UI 160a in FIG. 1A and the agent being notified to focus on the emergency interaction.

According to some embodiments of the present disclosure, the interaction-handler module may notify the recommendation engine 840. The notification to the recommendation engine, as shown in FIG. 5, which may be presented on the supervisor dashboard and may be used by the supervisor to monitor the emergency interaction through the dashboard by notifying with emergency visual indicator with the contact and agent who is handling the emergency, for example as shown in FIG. 14.

According to some embodiments of the present disclosure, once the emergency-mode is turned ‘on’, the agent state is updated to ‘Emergency’ 850 which is unavailable code in the ACD application to make sure no further cases are assigned to the agent, till the agent finish handling the emergency interaction.

According to some embodiments of the present disclosure, while the agent is handling the emergency interaction, other existing real-time non-emergency interactions handled by agent are re-queued to other available agents 860 and all other asynchronous, e.g., non-real-time, non-emergency interactions may be defocused 870, and the agent is enforced not to focus on the non-emergencies until the emergency interaction is resolved.

According to some embodiments of the present disclosure, the interaction-handler module may check if all emergency interactions are processed or not 880. In case there are emergency interactions available to interaction-handler module, process 810-870 may be operated.

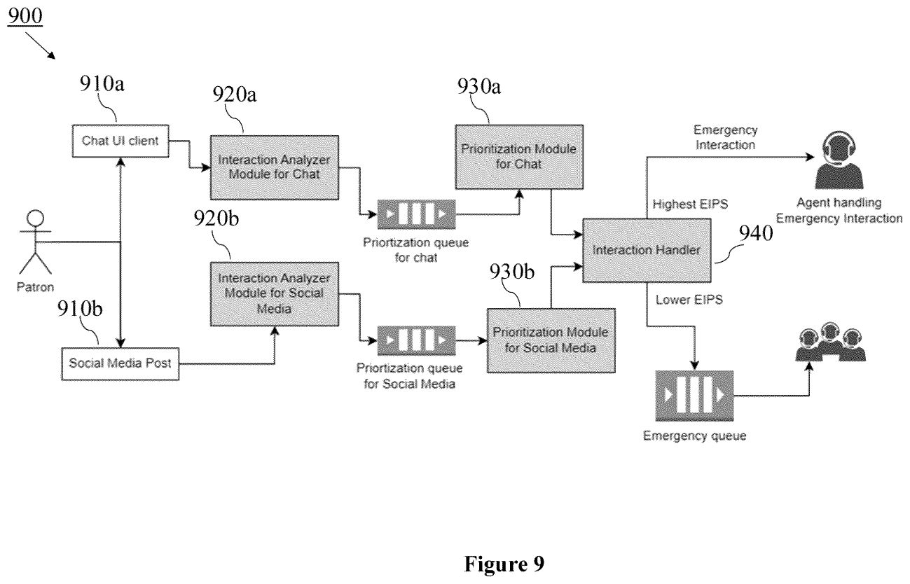

FIG. 9 schematically illustrates a high-level diagram of a system 900 for handling emergency digital interactions in a contact center having agents handling concurrent interactions, in accordance with some embodiments of the present disclosure.

According to some embodiments of the present disclosure, a customer may initiate a digital interaction such as chat via a UI 910a or social media post 910b and the digital interaction is assigned to the agent. The digital interaction may be analyzed by an interaction-analyzer module in real-time, e.g., interaction-analyzer module for chat 920a or interaction-analyzer module for social media 920b where the digital interaction may be captured with various interaction related attributes identified, e.g., interaction-metadata, like emergency keywords, customer emotions, sentiments and the like.

According to some embodiments of the present disclosure, once the interaction is identified as an emergency, an EIPS may be calculated by a prioritization module, such as prioritization module for chat 930a and prioritization module for social media 930b for all the emergency interactions. The emergency-mode can be turned on and off for the interaction. All non-emergency interactions may be re-queued.

According to some embodiments of the present disclosure, an interaction-handler module 940 may be operated to prioritize the monitored real-time digital-interaction when the emergency-mode has been set to ‘on’ and move the agent into emergency-handling-mode.

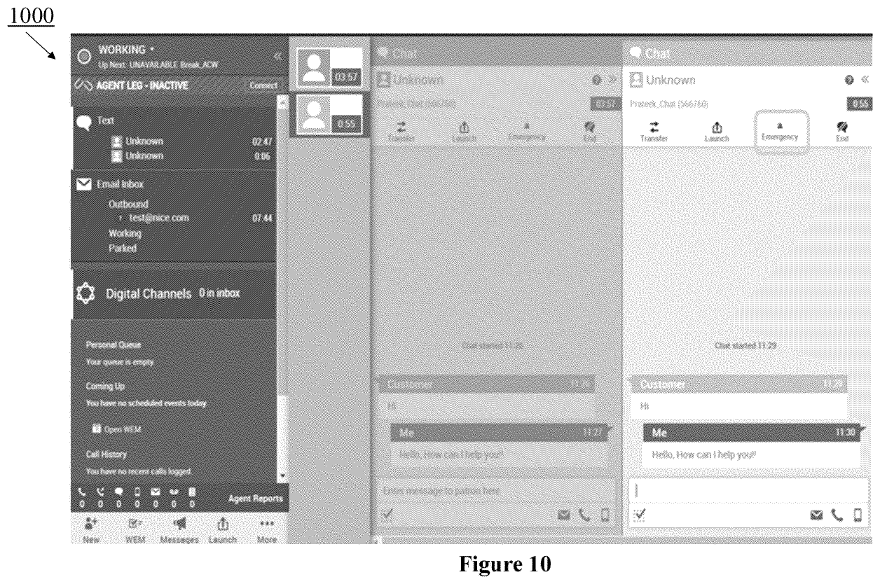

FIG. 10 illustrates a screenshot of a User Interface (UI) 1000 for agent interactions with customers when emergency-mode is ‘off’, in accordance with some embodiments of the present disclosure.

According to some embodiments of the present disclosure, in a system, such as system 100A and such as system 100B, an agent may interact with concurrent contacts which are non-emergency, via UI 1000 and the emergency-mode is turned off for these interactions. As the messages are being exchanged between agent and patron, the interaction is analyzed continuously.

FIG. 11 illustrates a screenshot of a UI 1100 for agent interactions with customers when emergency-mode is ‘on’ and emergency pop-up, in accordance with some embodiments of the present disclosure.

According to some embodiments of the present disclosure, in a system, such as system 100A in FIG. 1A and such as system 100B in FIG. 1B when the agent is handling an emergency interaction then in UI such as UI 1100 the emergency mode is turned on for the agent. An emergency visual indicator is displayed with the contact type, e.g., chat. An emergency contact popup is displayed to the agent, when the agent is working on an emergency interaction. Also, the agent state is updated with emergency unavailable code in the ACD application, such that the ACD application doesn't route new interactions to the agent, while the agent is handling the emergency interaction. The emergency level is displayed on contact typer header.

FIG. 12 illustrates a screenshot of a UI 1200 for agent interactions with customers when emergency-mode is ‘on’, after user click on pop-up, in accordance with some embodiments of the present disclosure.

According to some embodiments of the present disclosure, in a system, such as system 100A in FIG. 1A and such as system 100B in FIG. 1B when the agent is handling an emergency interaction then once the agent clicks on “Got It” button of emergency popup message, as shown in UI 1100 in FIG. 11 then the agent state remains as emergency as agent is working on an emergency contact. All the real-time non-emergency contacts are re-queued to other agents which are not handling any emergency interactions. The emergency-mode for the interaction is set to ‘on’ and an indicator is displayed with the contact type. All non-real-time non-emergency interactions remain in the agent queue.

FIG. 13 illustrates a screenshot of a UI 1300 for agent interactions with customers when emergency-mode is ‘on’, and a warning pop-up after the agent clicks to move to a non-emergency interaction, in accordance with some embodiments of the present disclosure.

According to some embodiments of the present disclosure, in a system, such as system 100A in FIG. 1A and such as system 100B in FIG. 1B when the agent is handling an emergency interaction then a warning popup may be displayed to the agent, whenever the agent tries to move to other non-emergency interaction assigned to agent at the time of handling the emergency interaction. Thus, forcing the agent to move to any other non-emergency interaction without completing the emergency interaction.

FIG. 14 illustrates a screenshot of a dashboard 1400 for a supervisor to monitor emergency interactions, in accordance with some embodiments of the present disclosure.

According to some embodiments of the present disclosure, in a system, such as system 100A in FIG. 1A and such as system 100B in FIG. 1B when the agent is handling an emergency interaction, then the emergency interaction may be monitored via a supervisor dashboard to monitor. The dashboard may display all active emergency contacts currently being handled by agents, with the EIPS, emergency level and duration of emergency interaction. The contact may be marked with an emergency indicator 1410.

It should be understood with respect to any flowchart referenced herein that the division of the illustrated method into discrete operations represented by blocks of the flowchart has been selected for convenience and clarity only. Alternative division of the illustrated method into discrete operations is possible with equivalent results. Such alternative division of the illustrated method into discrete operations should be understood as representing other embodiments of the illustrated method.

Similarly, it should be understood that, unless indicated otherwise, the illustrated order of execution of the operations represented by blocks of any flowchart referenced herein has been selected for convenience and clarity only. Operations of the illustrated method may be executed in an alternative order, or concurrently, with equivalent results. Such reordering of operations of the illustrated method should be understood as representing other embodiments of the illustrated method.

Different embodiments are disclosed herein. Features of certain embodiments may be combined with features of other embodiments; thus, certain embodiments may be combinations of features of multiple embodiments. The foregoing description of the embodiments of the disclosure has been presented for the purposes of illustration and description. It is not intended to be exhaustive or to limit the disclosure to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the disclosure.

While certain features of the disclosure have been illustrated and described herein, many modifications, substitutions, changes, and equivalents will now occur to those of ordinary skill in the art. It is, therefore, to be understood that the appended claims are intended to cover all such modifications and changes as fall within the true spirit of the disclosure.

What is claimed:

1. A computerized-method for handling emergency digital interactions in a contact center having agents handling concurrent interactions, said computerized-method comprising:
for each agent in the contact center:
(i) monitoring each real-time digital-interaction of an agent with a customer,
that was routed by an Advanced Contact Distributor (ACD) application, wherein the agent is concurrently handling two or more interactions via a User Interface (UI) that is associated to an application for handling concurrent interactions;
(ii) operating an interaction-analyzer module on the monitored real-time digital-interaction to yield interaction-metadata;
(iii) operating a prioritization module on the yielded interaction-metadata of the monitored real-time digital-interaction to set an emergency-mode thereto,
wherein the emergency-mode is one of: ‘on’ and ‘off’; and
(iv) operating an interaction-handler module to prioritize the monitored real-time digital-interaction when the emergency-mode has been set to ‘on’ and move the agent into emergency-handling-mode.

2. The computerized-method of claim 1, wherein said interaction-analyzer module comprising:
(i) checking one or more preconfigured parameters in the real-time-digital-interaction wherein each parameter in the one or more preconfigured parameters is related to one category of: a. critical service; b. customer behavior; and customer information; and
(ii) scoring each parameter in the one or more parameters based on preconfigured mapping values to yield the interaction-metadata.

3. The computerized-method of claim 2, wherein said prioritization module comprising:
(i) setting the emergency-mode to ‘on’ according to formula I:
$$If \sum ( preconfigured emergency keywords unique occurrence count in interaction ) > x set emergency - mode to ‘ on ’ , \qquad ( I )$$
whereby x is a positive number greater than ‘0’,
(ii) calculating an Emergency Interaction Priority Score (EIPS) for each real-time digital-interaction that the emergency-mode has been set to ‘on’, based on the interaction-metadata,
wherein said calculating of the EIPS is according to formula II:
$$EIPS = \sum ( parameters score related to critical service * W 1 ) + ( parameters score related to customer behavior * W 2 ) + ( parameters score related to customer information * W 3 ) ; \qquad ( II )$$
whereby:
W1-W3 are weights assigned to the parameters score,
and
(iii) prioritizing the real-time digital-interactions in descending order of EIPS.

4. The computerized-method of claim 1, wherein said two or more interactions include at least one of: real-time interactions and asynchronous interactions.

5. The computerized-method of claim 1, wherein the interaction-handler module is prioritizing the monitored real-time digital-interaction when the emergency-mode has been set to ‘on’ by moving real-time digital-interactions that their emergency-mode is not set to ‘on’ to other agents and defocusing asynchronous interactions.

6. The computerized-method of claim 1, wherein the interaction-handler module further comprising: monitoring the prioritized real-time digital-interaction to determine completion thereof and moving the agent out from the emergency-handling-mode.

7. The computerized-method of claim 1, wherein when the agent is moved into emergency-handling-mode the computerized-method further comprising displaying a pop-up message on the UI.

8. The computerized-method of claim 1, wherein when the agent is moved into emergency-handling-mode the computerized-method further comprising displaying an icon indicating the emergency-handling-mode of the agent on the UI.

9. The computerized-method of claim 1, wherein when the agent is moved into emergency-handling-mode the computerized-method further comprising: (i) displaying an emergency visual indicator with the interaction type on the UI; and (ii) configuring the ACD application to set a status of the agent to ‘emergency-unavailable’, wherein when the status of the agent is set to ‘emergency-unavailable’ the ACD application is not routing any interaction to the agent.

10. The computerized-method of claim 1, wherein when the agent completes the prioritized monitored real-time digital-interaction, the computerized-method further comprising setting the emergency-mode to ‘off’ and moving the agent out of emergency-handling-mode.

11. The computerized-method of claim 1, wherein the computerized-method further comprising determining an emergency category to the monitored real-time digital-interaction when the emergency-mode has been set to ‘on’, based on preconfigured mapping.

12. The computerized-method of claim 11, wherein when the agent is moved into emergency-handling-mode the computerized-method further comprising displaying the emergency category on the UI in a section related to the monitored real-time digital-interaction.

13. The computerized-method of claim 1, wherein the computerized-method further comprising determining an emergency category to the monitored real-time digital-interaction when the emergency-mode has been set to ‘on’, based on preconfigured mapping.

14. The computerized-method of claim 10, wherein when the agent is moved into emergency-handling-mode the computerized-method further comprising displaying the emergency category on the UI in a section related to the monitored real-time digital-interaction.

15. The computerized-method of claim 3, wherein when more than one real-time digital-interaction has been set to ‘on’, the computerized-method further comprising prioritizing the real-time digital-interactions, based on the calculated EIPS.

16. The computerized-method of claim 1, wherein the application for handling concurrent interactions receives voice and digital interactions.
